(19) United States
(12) Patent Application Publication
(10) Pub. No.: US 2008/0123125 A1
(43) Pub. Date: May 29, 2008

(54) INFORMATION PROCESSING SYSTEM, INFORMATION PROCESSING APPARATUS, AND INFORMATION PROCESSING METHOD

(75) Inventor: Shin Fukuda, Port Washington, NY (US)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/945,158

(22) Filed: Nov. 26, 2007

(30) Foreign Application Priority Data
Nov. 27, 2006 (JP) 2006-318658

(51) Int. Cl. G06F 3/12

(52) U.S. Cl. 358/1.13

(57) ABSTRACT

An information processing system which makes it possible to enable the effective use of an optional function (surplus optional function) remaining in an unusable state. When one printing apparatus has optional function data (license or an application program) stored therein for execution of an optional function, without a required optional device mounted thereon, and another printing apparatus has the optional device mounted thereon without the optional function data, the optional function data is transferred from the one printing apparatus to the other printing apparatus. Upon reception of the optional function data, the optional function data is stored in a storage device of the printing apparatus. When the optional function data stored in the storage device, and the optional device is mounted, the optional function is caused to be executed.

### BACKGROUND OF THE INVENTION

1. Field of the Invention

The present invention relates to an information processing system, an information processing apparatus, and an information processing method.

2. Description of the Related Art

Conventionally, a printing apparatus as an information processing apparatus can be equipped with various optional devices (a finisher, a sheet feeding deck, a puncher, a folding device, a sound device, a card reader, a barcode reader, various media readers, etc.) according to various usage patterns of users. The installation or replacement of these optional devices has been executed by service persons.

However, to cope with the recent increase in the variety of the usage patterns of users, the printing apparatus is becoming more component-based. Therefore, there has recently been proposed a printing apparatus as an information processing system, with an operating panel and a scanner device, which have conventionally been irremovable, made removable as optional devices.

These optional devices are designed such that they can be replaced or reused, not only between apparatuses of the same machine type but also between apparatuses of different machine types, and it has become easy for users to carry out an installation or replacement operation thereof (see e.g. Japanese Laid-Open Patent Publication No. 2004-112627).

On the other hand, in a printing apparatus as an information processing apparatus, apart from optional devices, there are a lot of optional functions which are initially not permitted to use, but are made usable only by additionally spending on them. One method of providing optional functions is licensing.

According to this method, part (optional function) of the functions of a program stored in advance in the printing apparatus as an information processing apparatus are provided in an disabled state, and after confirming that the user is licensed, the disabled part i.e. the optional function is validated or enabled to permit the use thereof thereafter.

The optional functions for licensing include, for example, a WEB browser function, a background pattern printing, and an application data direct printing function. Further, another method of providing optional functions is to provide them in the form of application programs.

According to this method, an application program which realizes an optional function but is not installed in the product in advance is additionally installed to permit the use of the optional function afterwards. In recent printing apparatuses as information processing apparatuses, there is installed a mechanism for storing programs which operate on a platform typified by JAVA® and Linux® via a communication line into a RAM or HDD for use.

Although mechanisms for realizing a desired configuration of a device (information processing apparatus) so as to make the device adapted to the environment of a user, by enabling the user to easily install or replace an optional device have been realized as described above, the above-mentioned capability of freely replacing optional devices brings about the problem of complicating the management of optional functions.

There occur cases where even when a certain optional function has been made valid with an authorized license, actually, the optional function remains unusable due to the state of attachment of the associated optional device to the device (information processing apparatus).

As an example of such an optional function, there may be mentioned a function which is provided with the prerequisite of the use of a scanner but actually is validated for a printing apparatus from which the scanner is removed, e.g. a function of converting a scanned image into a specific image format, such as PDF. Further, there may be mentioned a card authenticating function validated for a printing apparatus from which a card reader is removed, a WEB browser function validated for a printing apparatus from which a display is removed.

As described above, there occurs an inconvenience in which an optional function cannot be used due to removal of the associated optional device from the information processing apparatus, making useless the license (usually required to be paid for) which is acquired for the purpose of using the optional function.

### SUMMARY OF THE INVENTION

The present invention provides an information processing system, an information processing apparatus, and an information processing method, which make it possible to enable the effective use of an optional function (surplus optional function) remaining in an unusable state.

In a first aspect of the present invention, there is provided an information processing system including a first information processing apparatus on which an optional device for executing an optional function can be mounted, and a second information processing apparatus on which the optional device can be mounted, comprising a first storage unit that is provided in the first information processing apparatus and is capable of storing the optional function data for executing the optional function, a control unit that is configured to provide control such that when the first information processing apparatus has received the optional function data from the second information processing apparatus, the optional function data is caused to be stored in the first storage unit, a first execution unit that is configured be operable when the first storage unit has the optional function data stored therein, and the first information processing apparatus has the optional device mounted thereon, to cause the first information processing apparatus to execute the optional function using the optional device, a second storage unit that is provided in the second information processing apparatus and is capable of storing the optional function data, a second execution unit that is configured to be operable when the second storage unit has the optional function data stored therein, and the second information processing apparatus has the optional device mounted thereon, to cause the second information processing apparatus to execute the optional function using the optional device, and a transfer unit that is configured to be operable when the first storage unit does not have the optional function data stored therein, and the first information processing apparatus has the optional device mounted thereon, and when the second storage unit has the optional function data stored therein, and the second information processing apparatus does not have the optional device mounted thereon, to transfer the optional function data from the second information processing apparatus to the first information processing apparatus.

According to the first aspect of the present invention, an optional function which has been made unusable by removal of an optional device or elimination of an optional function from one information processing apparatus is transferred to another information processing apparatus which can make use of the optional function. Therefore, it is possible to make effective use of an optional function (surplus optional function) left in an unusable state.

The transfer unit is configured to be operable when the first information processing apparatus sends a request for transfer of the optional function data, to the second information processing apparatus, to transfer the optional function data from the second information processing apparatus to the first information processing apparatus.

The information processing system can include a server apparatus that is configured to be capable of communicating with the first information processing apparatus and the second information processing apparatus, and the second information processing apparatus is configured to be operable when the second storage unit has the optional function data stored therein, and the second information processing apparatus does not have the optional device mounted thereon, to send both function identifying information for identifying the optional function and apparatus identifying information for identifying the second information processing apparatus to the server apparatus, the first information processing apparatus being configured to be operable when the first storage unit does not have the optional function data stored therein, and the first information processing apparatus has the optional device mounted thereon, to make a request for sending the apparatus identifying information associated with the function identifying information, to the server apparatus, the first information processing apparatus being configured to be operable in response to the sending of the function identifying information to the first information processing apparatus from the server apparatus, to send the transfer request to the second information processing apparatus based on the apparatus identifying information.

The apparatus identifying information includes an IP address.

The first information processing apparatus can include a first detection unit configured to detect mounting or removal of the optional device, and the first information processing apparatus is configured to be operable when the first storage unit does not have the optional function data stored therein, to send the transfer request to the second information processing apparatus in response to detection of mounting of the optional device by the first detection unit.

The second information processing apparatus can have a second detection unit configured to detect mounting or removal of the optional device, and the second information processing apparatus is operable when the second storage unit has the optional function data stored therein, to send both the function identifying information and the apparatus identifying information to the server apparatus in response to detection of removal of the optional device by the second detection unit.

The optional function data can be an execution program for executing the optional function.

The first storage unit and the second storage unit can store an execution program for executing the optional function, and the optional function data is license information for permitting the first execution unit or the second execution unit to execute the optional function based on the execution program.

In a second aspect of the present invention, there is provided an information processing apparatus that is configured to be capable of having an optional device mounted thereon for executing an optional function, and communicating with another information processing apparatus on which the optional device can be mounted, comprising a first storage unit that is configured to be capable of storing the optional function data for executing the optional function, a reception unit that is configured to be operable when the first storage unit does not have the optional function data stored therein, and the information processing apparatus has the optional device mounted thereon, and when a second storage unit provided in another information processing apparatus has the optional function data stored therein, and the other information processing apparatus does not have the optional device mounted thereon, to receive the optional function data from the other information processing apparatus, a control unit that is configured to provide control such that when the first information processing apparatus has received the optional function data from the second information processing apparatus, the optional function data is caused to be stored in the first storage unit, and an execution unit that is configured be operable when the first storage unit has the optional function data stored therein, and the first information processing apparatus has the optional device mounted thereon, to execute the optional function using the optional device.

The information processing apparatus can include a transmission unit configured to be operable when the first storage unit does not have the optional function data stored therein, and the information processing apparatus has the optional device mounted thereon, to make a request for sending the optional function data, to the other information processing apparatus, and the control unit can provide control such that when the optional function data has been received from the other information processing apparatus sent in response to sending of the transfer request, the optional function data is caused to be stored in the first storage unit.

The information processing apparatus can include a first detection unit configured to detect mounting or removal of the optional device, and the transmission unit is configured to be operable when the first storage unit does not have the optional function data stored therein, to send the transfer request to the other information processing apparatus in response to detection of mounting of the optional device by the detection unit.

The optional function data can be an execution program for executing the optional function.

The first storage unit can have an execution program stored therein for executing the optional function, and the optional function data can be license information for permitting the execution unit to execute the optional function based on the execution program.

In a third aspect of the present invention, there is provided an information processing apparatus that is configured to be capable of having an optional device mounted thereon for executing an optional function, and communicating with another information processing apparatus on which the optional device can be mounted, comprising a first storage unit that is capable of storing optional function data for executing the optional function, a transmission unit that is operable when the first storage unit has the optional function data stored therein, and the information processing apparatus does not have the optional device mounted thereon, and when a second storage unit provided in the other information processing apparatus does not have the optional function data stored therein, and the other information processing apparatus has the optional device mounted thereon, to send the optional function data to the other information processing apparatus, an execution unit that is configured be operable when the first storage unit has the optional function data stored therein, and the information processing apparatus has the optional device mounted thereon, to execute the optional function using the optional device.

The information processing apparatus can include a reception unit that is configured to receive a request for sending the optional function data, from the other information processing apparatus, and the transmission unit can send the optional function data to the other information processing apparatus in response to reception of the transfer request by the reception unit.

The optional function data can be an execution program for executing the optional function.

The first storage unit can have an execution program stored therein for executing the optional function, and the optional function data can be license information for permitting the execution unit to execute the optional function based on the execution program.

In a fourth aspect of the present invention, there is provided a method of processing information in an information processing system including a first information processing apparatus on which an optional device for executing an optional function can be mounted, and a second information processing apparatus on which the optional device can be mounted, comprising a transfer step of transferring optional function data for executing the optional function from the second information processing apparatus to the first information processing apparatus, when a first storage unit of the first information processing apparatus does not have the optional function data stored therein, and the first information processing apparatus has the optional device mounted thereon, and when a second storage unit of the second information processing apparatus has the optional function data stored therein, and the second information processing apparatus does not have the optional device mounted thereon, a control step of providing control such that when the first information processing apparatus has received the optional function data from the second information processing apparatus, the optional function data is caused to be stored in the first storage unit, a first execution step of causing the first information processing apparatus to execute the optional function using the optional device when the first storage unit has the optional function data stored therein, and the first information processing apparatus has the optional device mounted thereon, and a second execution step of causing the second information processing apparatus to execute the optional function using the optional device, when the second storage unit has the optional function data stored therein, and the second information processing apparatus has the optional device mounted thereon.

The features and advantages of the invention will become more apparent from the following detailed description taken in conjunction with the accompanying drawings.

### BRIEF DESCRIPTION OF THE DRAWINGS

FIG. 1 is a functional block diagram of a printing apparatus as an information processing apparatus according to an embodiment of the present invention.

FIG. 2 is a flowchart of an optional function usable state-determining process executed by the printing apparatus in FIG. 1.

FIG. 3 is a view of a table indicative of correspondence between valid optional functions and required optional devices.

FIG. 4 is a view showing an example of a screen displayed on an operating panel during processing in a step S205 in FIG. 2.

FIG. 5 is a block diagram of a printing system including a printing apparatus as an information processing apparatus according to a second embodiment of the present invention.

FIG. 6 is a flowchart of a surplus optional function-detecting process executed by the printing system shown in FIG. 5.

FIGS. 7A and 7B are diagrams showing tables of information on surplus optional functions.

FIG. 8 is a flowchart of a surplus optional search process which is executed by the printing system shown in FIG. 5.

FIGS. 9A and 9B are views showing examples of screens notifying the user of results of search for surplus options.

FIGS. 10A and 10B are respective flowcharts of processes for transferring and receiving a surplus optional function which are executed by the printing system shown in FIG. 5.

FIGS. 11A, 11B, and 11C are views showing examples of screens for notifying the user of respective results of reception of an optional function.

FIG. 12 is a block diagram of a printing system including a printing apparatus as an information processing apparatus according to a third embodiment of the present apparatus.

FIG. 13 is a flowchart of an optional device mounting/removing information-processing process which is executed by the printing system shown in FIG. 12.

FIGS. 14A and 14B are diagrams showing tables of information on optional devices.

FIG. 15 is a flowchart of a process executed by the printing system shown in FIG. 12 when an optional device is mounted.

FIGS. 16A and 16B are diagrams showing respective examples of UI screens displayed in a step S1506 in FIG. 15.

### DETAILED DESCRIPTION OF THE PREFERRED EMBODIMENTS

The present invention will now be described in detail with reference to the drawings showing preferred embodiments thereof.

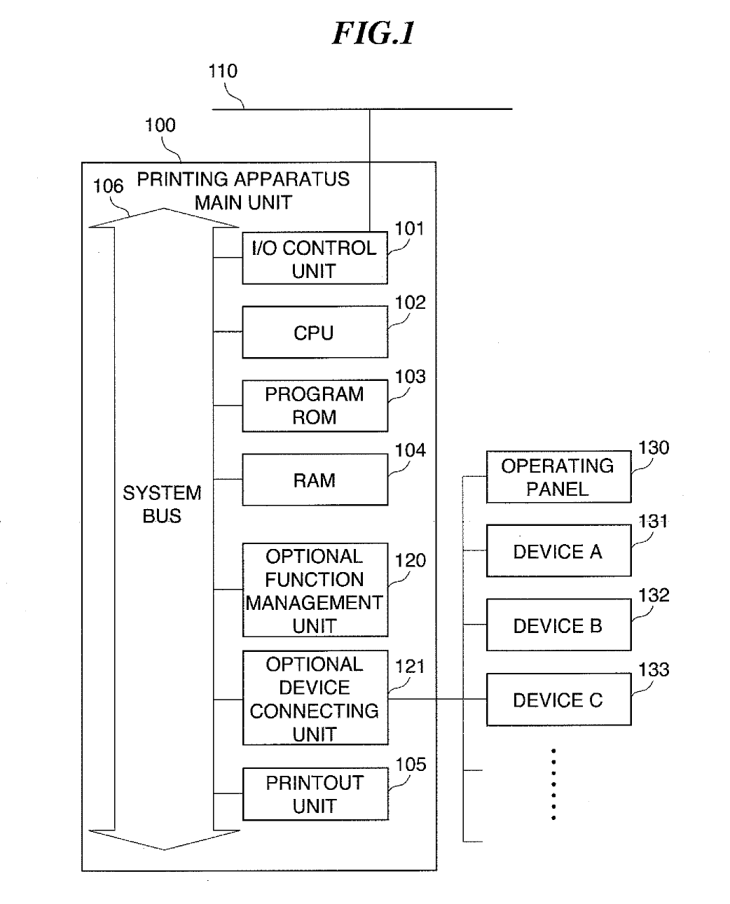

FIG. 1 is a block diagram of a printing apparatus as an information processing apparatus according to a first embodiment of the present invention.

In FIG. 1, the printing apparatus as an information processing apparatus as one aspect of the present invention is comprised of a printing apparatus main unit 100, and four types of optional devices, i.e. an operating panel 130, a device A 131, a device B 132, and a device C 133. The operating panel 130 is a touch panel for operating the printing apparatus main unit 100, and is capable of detecting an input by the user and notifying information to the user via GUI.

In the printing apparatus main unit 100, an I/O control unit 101 controls communication to external network devices, not shown, via a LAN (communication line). A CPU 102 is a computing unit which performs various processes in the printing apparatus main unit 100. A program ROM 103 stores programs to be executed by the CPU 102.

A RAM 104 is a memory area which the CPU 102 uses for various processes. A printout unit 105 physically records processed print data on printing sheets. Modules of the printing apparatus main unit 100 are capable of communicating with each other via a system bus 106.

An optional function management unit 120 manages licenses and additional applications in the printing apparatus main unit 100. In the present embodiment, the term “optional function” is intended to mean a function which cannot be used in an initial state of a product of the printing apparatus but can be made usable by additionally spending thereon (by purchasing an application program or a license). An optional function in the form of an application program is stored in the ROM 103 or in a non-volatile storage medium (not shown), such as a hard disk, provided in the printing apparatus.

As a method of adding an optional function, there are a license adding method and an application adding method.

In the case of the license adding method, a program for realizing the optional function is stored in the program ROM 103 beforehand. The optional function management unit 120 receives license information from an external apparatus, not shown, via the LAN 110, and stores information on the fact that the license has been validated, in the RAM 104. The license information is used for validating, i.e. enabling the optional function, and is provided in form of electronic data as a license file.

The CPU 102 reads out license information stored in the RAM 104 and reads out a program associated with the license from the ROM 103 to execute the same. The license information may be notified to the optional function management unit 120 by the user operating the operating panel 130.

On the other hand, in the case of the application adding method, the optional function management unit 120 receives an application program from an external apparatus, not shown, via the LAN 110, and stores the application program in the RAM 104. The CPU 102 reads out the application program stored in the RAM 104, and executes the same. In the case of adding an application program as well, license information may be made necessary.

An optional device connecting unit 121 controls communication and the like between the printing apparatus main unit 100 and an optional device connected thereto.

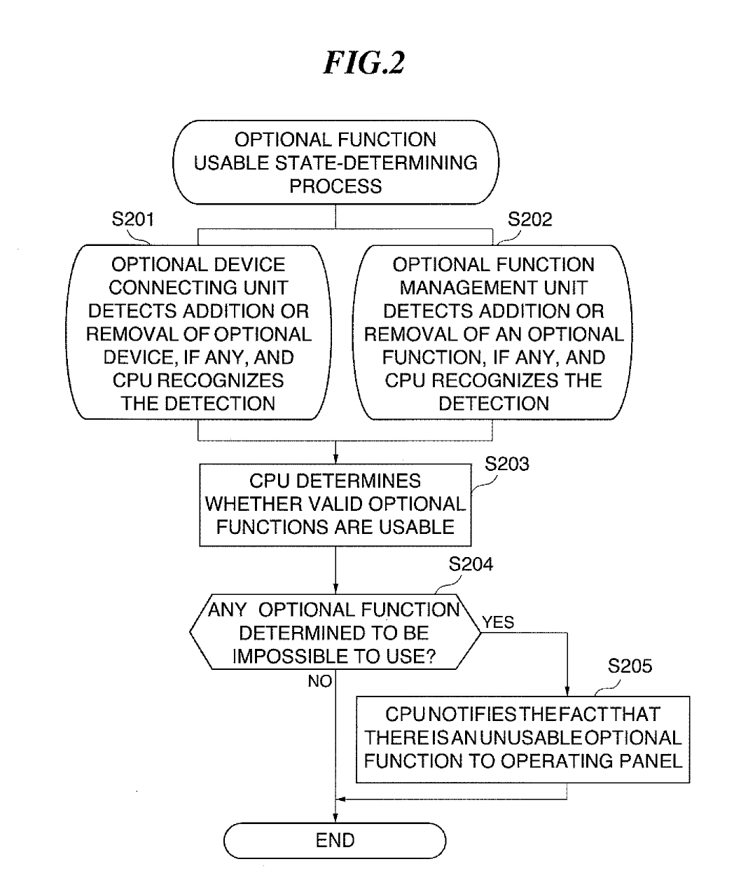

FIG. 2 is a flowchart of an optional function usable state-determining process executed by the printing apparatus in FIG. 1, for determining whether optional functions are in a usable state or in an unusable state. This process is executed by the CPU 102.

In FIG. 2, the optional device connecting unit 121 detects addition or removal of an optional device, if any, and the CPU 102 recognizes the detection (step S201). Further, the optional function management unit 120 detects addition or removal of an optional function, if any, and the CPU 102 recognizes the detection (step S202). If any detection is recognized in the step S201 or the S202, the CPU 102 determines whether valid optional functions are usable (step 203).

If there is any optional function which is determined to be impossible to use (YES to the step S204), the CPU 102 notifies the fact that there is an unusable optional function to the operating panel 130 (step S205), followed by terminating the process. On the other hand, if it is determined in the step S204 that there is no unusable optional function (NO to the step S204), the process is immediately terminated.

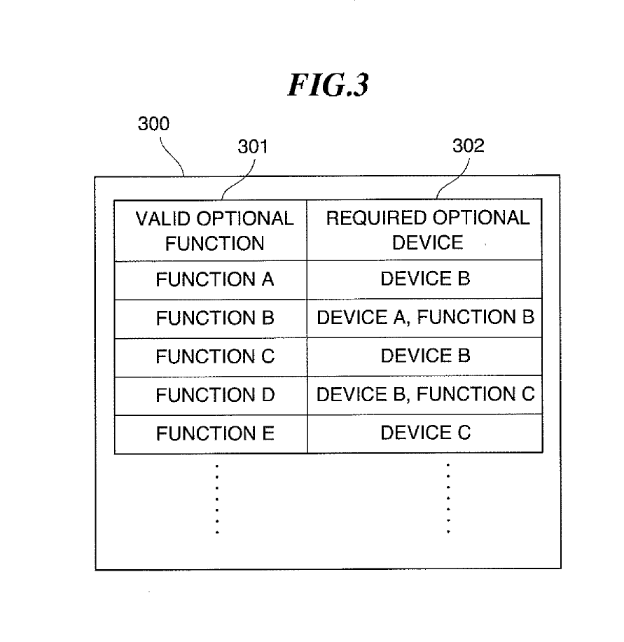

FIG. 3 is a view of a table indicative of correspondence between valid optional functions and required optional devices. This table is stored in the optional function management unit 120.

In FIG. 3, a table 300 associates optional functions 301 and optional devices 302 required for the respective optional functions 301 to operate, with each other. Each optional function 301 indicates an optional function made valid in the printing apparatus 100. Further, each optional device 302 indicates an optional device required by the valid optional function, and in addition thereto, another optional function required thereby, if any. The optional function management unit 120 stores the table 300, and determines whether or not each optional function is usable by looking it up. The step S204 in FIG. 2 is executed based on the result of the determination.

FIG. 4 is a view showing an example of a screen displayed on the operating panel 130 in the step S205 in FIG. 2.

As illustrated in FIG. 4, the screen shows names 401 of valid optional functions in the printing apparatus 100, and respective states of the valid optional functions indicated by the names 401. The illustrated screen shows that a function B and a function E are have valid licenses but are unusable. From this screen, the user can recognize that there is a surplus optional device, i.e. an optional function which, in spite of the fact that the function is made valid e.g. by applying a license thereto, cannot be executed since an optional device required for executing the function is not provided. Further, in the state 402, there is also displayed a reason why the optional function cannot be used.

In the present embodiment, since the operating panel 130 itself is an optional device, there can be a case in which the printing apparatus main unit 100 does not have the operating panel 130 mounted thereon. In such a case, an electronic mail containing a message equivalent to the contents of the display in FIG. 4 may be sent to an electronic mail address of the administrator of the printing apparatus. If there is any addition or removal of an optional device, or if there is an optional function made valid anew, or if a valid optional function is made invalid, it is only required to send such an electronic mail to the address.

From the processing described above, it is possible to notify the user of an optional function which is made usable or unusable by addition or elimination of an optional device or an optional function. Therefore, the administrator or user of the printing apparatus can recognize an optional function which is made usable or unusable based on the notification, and then can take an action of transferring the license of the optional function to another printing apparatus, for example, so as to make effective use of the license for the function.

Although in the first embodiment described above, a surplus optional function, if any, is only notified to the user, next, a description will be given of a printing apparatus as an information processing apparatus according to a second embodiment of the present invention in which a surplus optional function can be transferred from the printing apparatus to another printing apparatus.

Now, the “transfer of an optional function” is intended to mean transfer of license information in the case where the optional function is to be made valid by the license, whereas in the case where the optional function is realized by an additional application program, the same is intended to mean transfer of the application program itself. Further, there is also a case where the optional function is realized by an additional application program, and the additional application program itself is made valid by applying correct license information thereto. In such a case, the transfer of an optional function is realized by transferring both the application program and license information corresponding thereto. It should be noted that the description of the present embodiment will be given of only different points from the first embodiment, but components and elements having the same respective configurations are indicated by the same reference numerals, and description thereof is omitted.

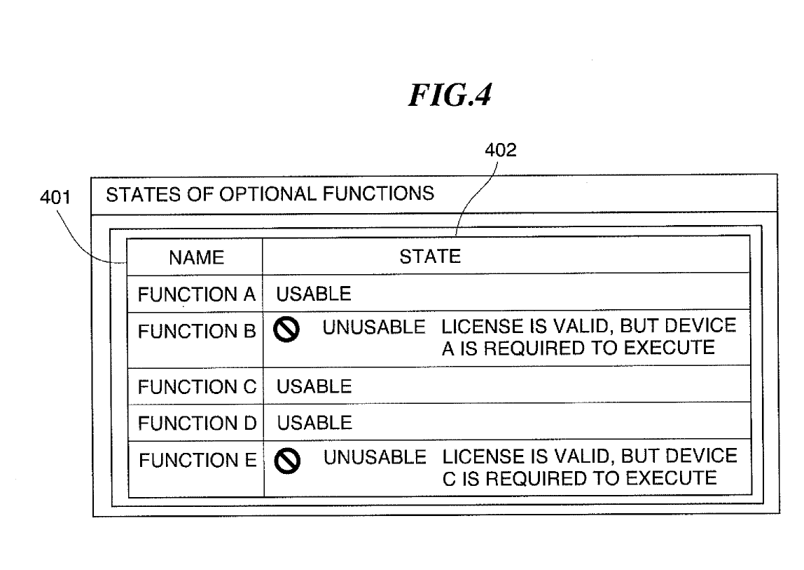

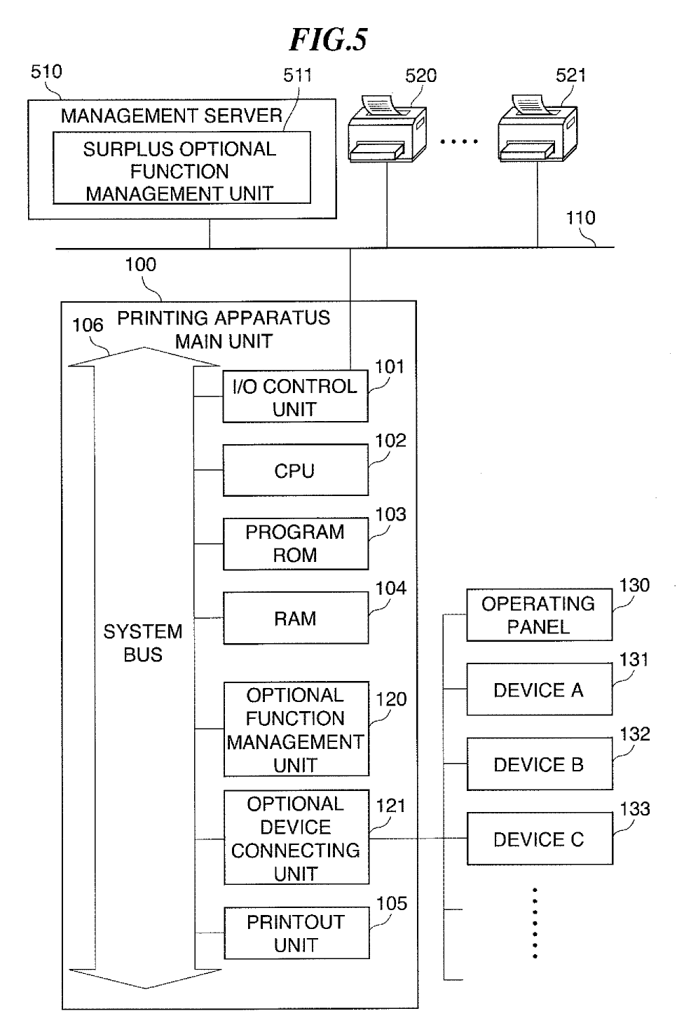

FIG. 5 is a block diagram of a printing system including a printing apparatus as an information processing apparatus according to a second embodiment of the present invention.

In FIG. 5, the present printing system includes the printing apparatus main unit 100, a management server 510, and other printing apparatuses 520, 521, . . . , which are connected to each other via the LAN 110.

A surplus optional function search unit 501 searches surplus optional functions managed by the management server 510 for a surplus optional function which can be used in the printing apparatus. A surplus optional function transfer unit 502 transfers a surplus optional function to another printing apparatus. A surplus optional function-receiving unit 503 receives a surplus optional function from another printing apparatus.

The management server 510 includes a surplus optional function management unit 511 which manages surplus optional functions in any of the printing apparatuses connected to the present printing system. The printing apparatus 520 and 521 connected to the present printing system are configured similarly to the printing apparatus main unit 100. It should be noted that there are cases where the printing apparatus 520 and the printing apparatus 521 also have the same optional devices mounted thereon as those of the printing apparatus main unit 100, but those optional devices are not shown in FIG. 5.

Next, a description will be given of a process executed by the printing apparatus constructed as described hereinabove, for transferring an optional function to another printing apparatus.

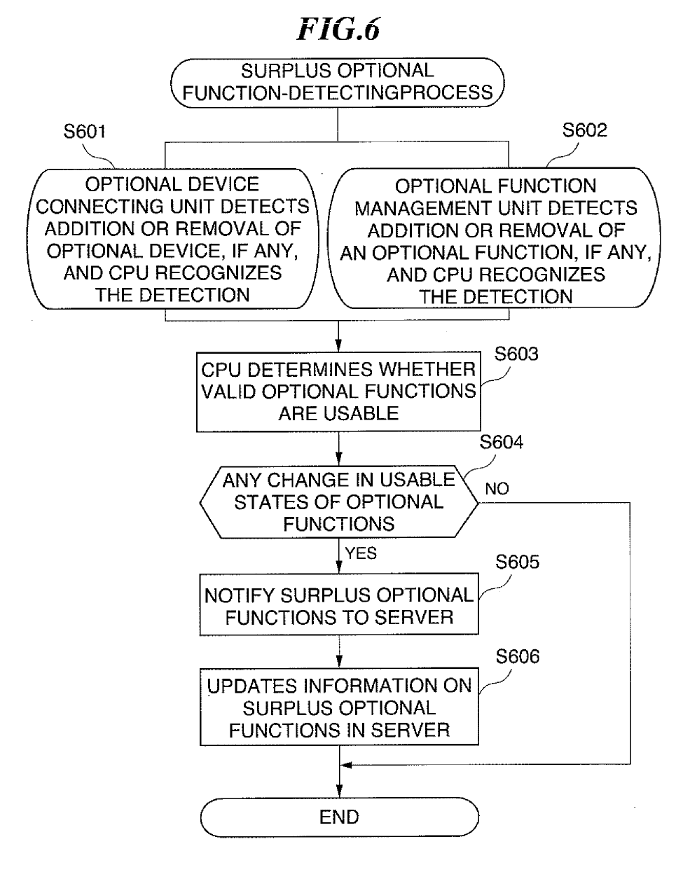

FIG. 6 is a flowchart of a surplus optional function-detecting process executed by the printing system shown in FIG. 5. The present process is executed by the CPU 102 of the printing apparatus main unit 100 and the management server 510 appearing in FIG. 5.

Referring to FIG. 6, the optional device connecting unit 121 detects addition or removal of an optional device, if any (step S601). Further, the optional function management unit 120 detects addition or elimination of an optional function, if any (step S602). If any detection occurs in the step S601 or S602, it is checked whether or not valid optional functions are usable (step S603).

If there is any change in the usable states of the optional functions (YES to S604), the currently unusable optional functions (hereinafter referred to as “surplus optional functions”) are notified to the management server 510 (step S605).

Next, the management server 510 receives the notification in the step S605, and the surplus optional device management unit 511 updates information on the surplus optional functions in the printing apparatus main unit 100 (step S606), followed by terminating the process. On the other hand, if there is no change in the usable and unusable states of the optional functions in the step S604 (N0 to S604), the present process is immediately terminated.

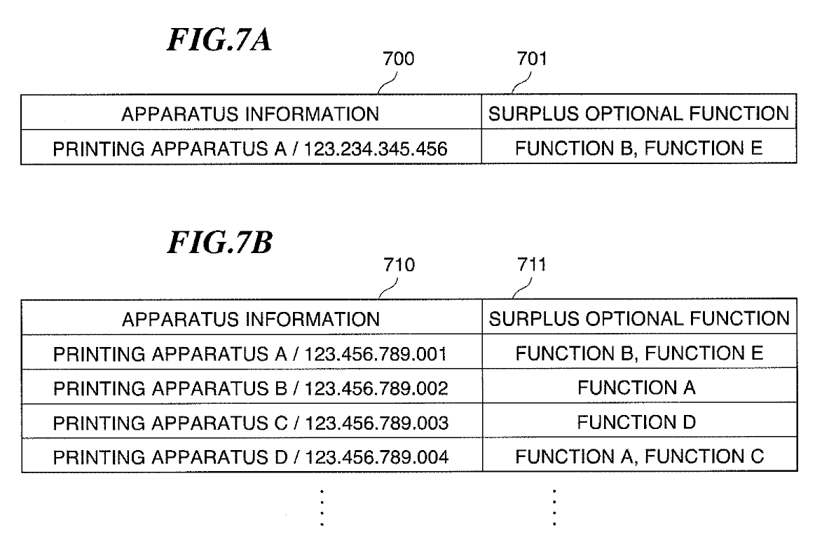

FIGS. 7A and 7B are diagrams showing tables of information on surplus optional functions.

In FIG. 7A, there is shown information on a surplus optional function notified from the printing apparatus main unit 100 to the management server 510 in the step S605 in FIG. 6. The box of apparatus information 700 stores the apparatus name (e.g. the name of a machine type) of the printing apparatus main unit 100 and an IP address thereof. As the apparatus information 700, there may be stored identification information (serial number) unique to the apparatus. The box of a surplus optional function stores information on the surplus optional function of the printing apparatus main unit 100.

FIG. 7B shows a table stored and updated in the surplus optional function management unit 511 in the step S606 in FIG. 6, which shows states of surplus optional functions of the printing system.

When notified of information shown in FIG. 7A from each printing apparatus, the surplus optional function management unit 511 updates the information stored in the table shown in FIG. 7B. Each box of apparatus information 710 stores the apparatus name (e.g. the name of a machine type) of each printing apparatus and an IP address, while each box of a surplus optional function 711 represents a surplus optional function of each printing apparatus. As described above, the surplus optional function management unit 511 manages surplus optional functions of the printing apparatuses in a manner associated with the printing apparatuses, respectively.

FIG. 8 is a flowchart of an optional function search process executed in the printing system in FIG. 5. This process is executed by the CPU 102 of the printing apparatus main unit 100 and the management server 510 appearing in FIG. 5.

In FIG. 8, the user issues an instruction for searching for surplus operational functions by using the operating panel 130. Upon receipt of the search instruction, the surplus optional function search unit 501 sends a request for searching for surplus options to the management server 510 (step S801).

Upon receipt of the search request, the management server 510 notifies information on the surplus optional functions of the printing apparatuses (see FIG. 7B) managed by the surplus operational function management unit 511 to the printing apparatus main unit 100 which made the request (step S802).

Next, the optional function management unit 120 determines whether or not any of the surplus optional functions notified in the step S802 can be used by the local apparatus to which the optional function management unit 120 belongs (step S803).

If it is determined in that there are surplus optional functions which can be used in the local apparatus (YES to the step S803), the surplus optional functions which can be used in the local apparatus are displayed on the operating panel 130 and selection by the user is accepted (step S804), followed by the present process.

Here, the “surplus optional function which can be used in the local apparatus” is intended to mean an optional function which can become capable of being executed by the local apparatus since an optional device required for the optional function has been mounted on the local apparatus, but cannot be used at present since it is not validated or an additional application program is not installed for realizing the optional function. An optional function which can be executed and has already been validated in the local apparatus is not within the category of the “surplus optional function which can be used in the local apparatus”. Further, an optional function which cannot be executed by the local apparatus even if it is made valid since a required optional device has not been mounted on the local apparatus is not within the category of the “surplus optional function which can be used in the local apparatus”, either.

On the other hand, if in the step S803, it is determined that there are no surplus optional functions which can be used in the local apparatus (NO to the step S803), a message saying that there is no surplus optional functions which can be used in the local apparatus is displayed on the operating panel 130 (step S805), followed by terminating the process.

In the present embodiment, search for surplus optional functions is executed by a user's instruction. In this case, the user has to carry out the search by his/her own will, but the search may be caused to be automatically executed in response to the mounting of a new optional device on the printing apparatus main unit 100. Further, the printing apparatus main unit 100 may be periodically caused to access the management server 510, and search for surplus optional functions.

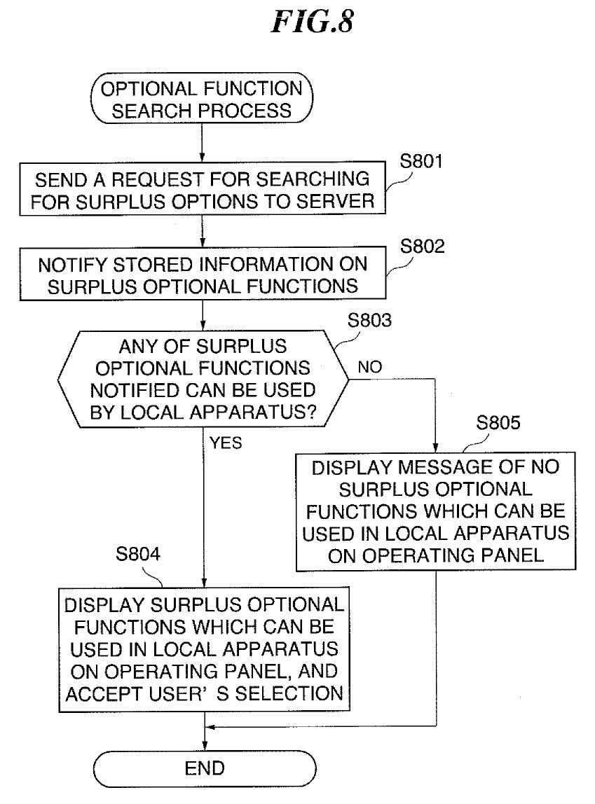

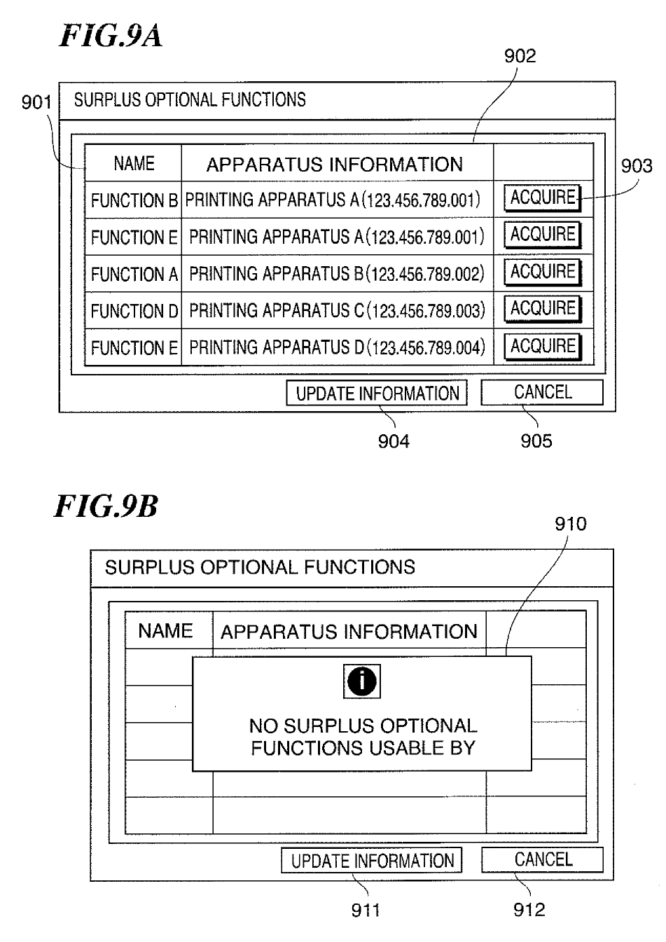

FIGS. 9A and 9B are views showing examples of screens notifying the user of results of search for surplus options.

FIG. 9A shows a screen displayed on the operating panel 130 in the step S804 in FIG. 8. Each name 901 indicates the name of a surplus optional function which can be used in the printing apparatus main unit 100. Each piece of apparatus information 902 shows apparatus information on a printing apparatus having a surplus optional function. In the illustrated example, there are displayed apparatus names (names of respective machine types) of printing apparatuses and IP addresses thereof.

By pressing an “acquire” button 903 for acquiring a surplus optional function, it is possible to acquire the function. A button 904 is for the user to instruct the update of the information on the surplus optional functions of the printing system. A cancel button 905 is for closing the screen without acquiring any surplus optional function.

FIG. 9B shows a screen displayed on the operating panel 130 in the step S805 in FIG. 8. A dialog 910 enables the user to recognize that the printing system currently has no surplus optional functions which can be used by the local apparatus. A button 911 is for the user to instruct the update of the information on the surplus optional functions of the printing system. A cancel button 912 is for closing the screen without acquiring any surplus optional function.

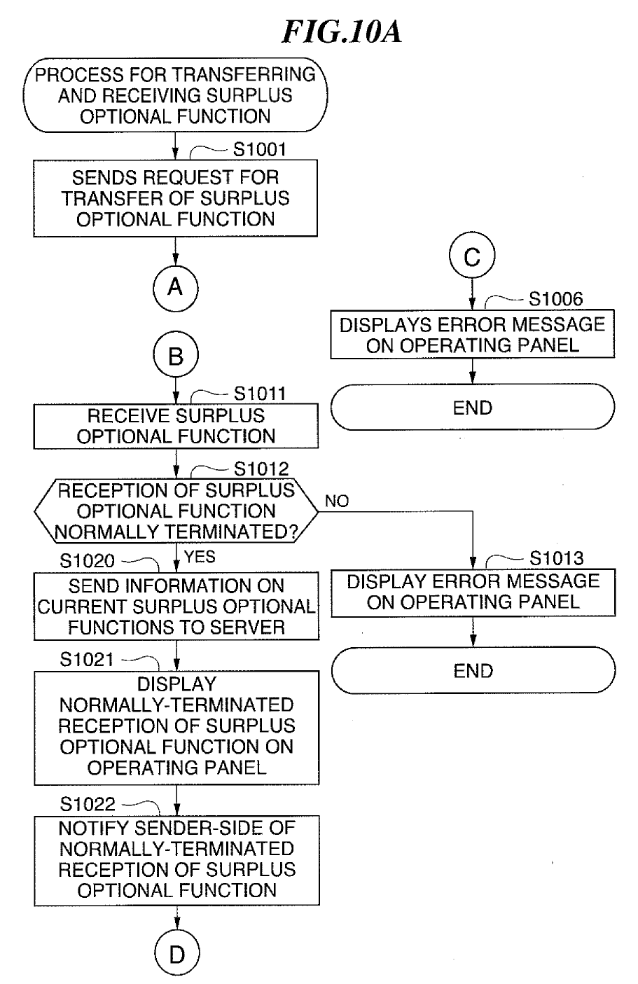

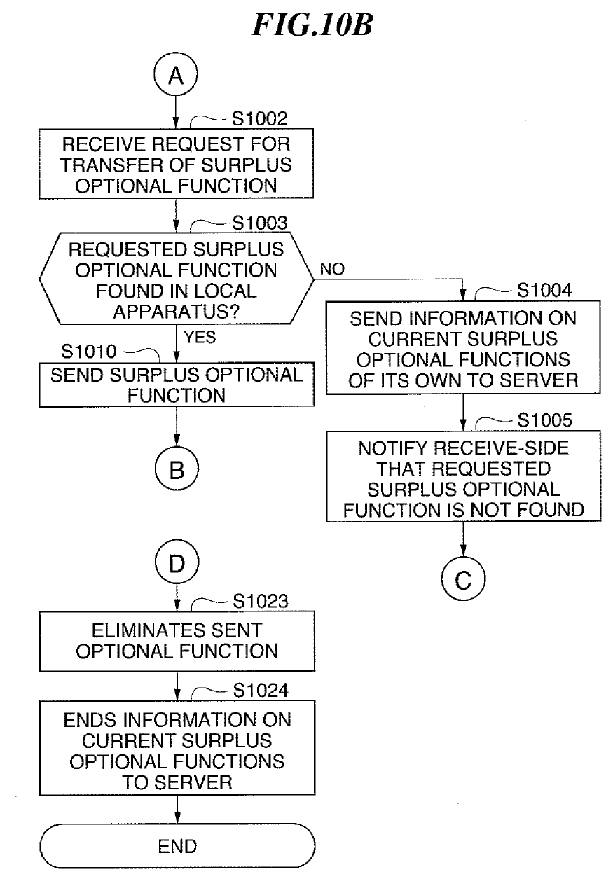

FIGS. 10A and 10B are respective flowcharts of processes for transferring and receiving a surplus optional function which are executed by the printing system shown in FIG. 5. The present process is executed by the CPU 102 of the printing apparatus main unit 100 in FIG. 5.

After the user presses the button 903 for acquiring a surplus optional function, the involved apparatuses execute transfer and reception processes for transfer and receipt of a surplus optional function therebetween. The transfer and receipt of the surplus optional function are carried out while the two printing apparatuses performing communication therebetween.

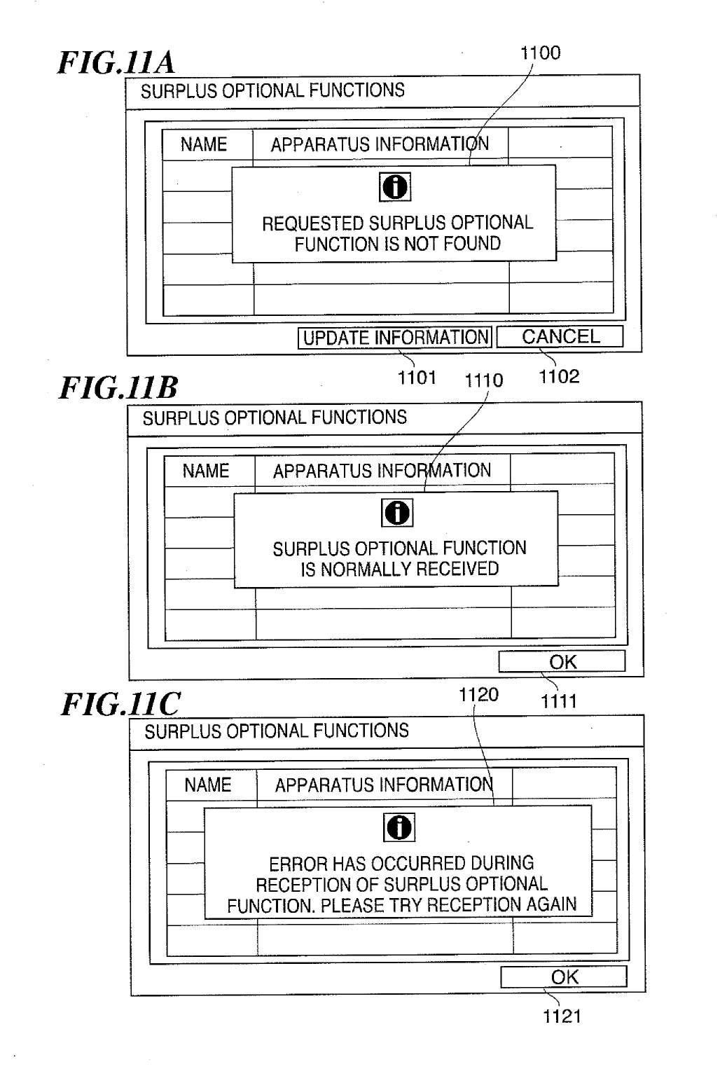

FIG. 11A shows a process executed by a receiver-side printing apparatus which receives an optional function, whereas FIG. 10B shows a process executed by a sender-side printing apparatus which transfers the optional function. Further, as mentioned hereinabove, since the printing apparatuses have the same configuration, the following description will be given using the reference numerals of the printing apparatus main unit 100 for both the receiver-side printing apparatus and the sender-side printing apparatus.

When the button 903 for acquiring a surplus optional function is pressed by the user, the surplus optional function-receiving unit 503 sends a request for transfer of the surplus optional function to the sender-side printing apparatus having the surplus optional function (step S1001). The sender-side printing apparatus receives the request sent in the step S1001 (step S1002).

Next, the optional function management unit 120 checks whether the local apparatus has the requested surplus optional function (step S1003). If the local apparatus does not have the requested surplus optional function (NO to the step S1003), the optional function management unit 120 sends information on the current surplus optional functions of its own to the management server 510 (S1004).

Next, the optional function management unit 120 notifies the receive-side printing apparatus of the fact that the requested surplus optional function is not found (step S1005). Upon receipt of the notification sent in the step S1005, the surplus optional function-receiving unit 503 displays an error message (step S1006), followed by terminating the present process.

On the other hand, if the requested surplus optional function is found (YES to the step S1003), the surplus optional function transfer unit 502 transfers the surplus optional function to the receiver-side printing apparatus (step S1010). The surplus optional function-receiving unit 503 of the receiver-side printing apparatus receives the surplus optional function sent in the step S1010 (step S1011).

Now, if the reception of the surplus optional function is not normally terminated (NO to a step S1012), an error message is displayed on the operating panel 130 (step S1013), followed by terminating the present process.

On the other hand, if the reception of the surplus optional function is normally terminated (YES to the step S1012), the surplus optional function-receiving unit 503 sends information on the current surplus optional functions to the management server 510 (step S1020). Next, a message saying to the effect that the surplus optional function has been normally received is displayed on the operating panel 130 (step S1021).

Next, the surplus optional function-receiving unit 503 notifies the sender-side printing apparatus of the fact that the surplus optional function has been normally received (step S1022). Upon receipt of the notification in the step S1022, the optional function management unit 120 of the sender-side printing apparatus eliminates the optional function from the sender-side printing apparatus (step S1023), and then sends information on the current surplus optional functions to the management server 510 (step S1024), followed by terminating the present process.

It should be note that the management server 510 having being notified of the updated information from in the step S0120 or the step S1024 updates the table indicative of states of the surplus optional functions which is stored in the surplus optional function management unit 511, based on the contents of the notification.

FIGS. 11A, 11B, and 11C are views showing examples of screens for notifying the user of respective results of reception of an optional function.

FIG. 11A shows a screen displayed on the operating panel 130 in the step S1006 in FIG. 10A. A dialog 1100 enables the user to recognize that the surplus optional function which the user requested to be sent from the sender-side printing apparatus is not found therein. A button 1101 is for the user to instruct the update of the information on the surplus optional functions of the printing system. A cancel button 1102 is for closing the screen without acquiring the surplus optional function.

FIG. 11B is shows screen displayed on the operating panel 130 in the step S1021 in FIG. 10A. A dialog 1110 enables the user to recognize that the surplus optional function which the user requested to be sent from the sender-side printing apparatus has been normally received. A button 1111 is for closing the present screen to return to the normal printing UI screen.

FIG. 11C shows a screen displayed on the operating panel 130 in the step S1013 in FIG. 10A. A dialog 1120 enables the user to recognize that an error has occurred during reception of the surplus optional function which the user requested to be sent from the sender-side printing apparatus. A button 1121 is for closing the present screen to return to the UI screen in FIG. 9A again.

The process described above makes it possible to make effective use of optional functions by transferring an optional function which has been made unusable by removal of an optional device or elimination of an optional function to another printing apparatus.

In the second embodiment, information on surplus optional functions can be acquired by the user performing a search for the information by his/her own will. In the third embodiment, a description will be given of a printing system which is capable of automatically acquiring information on the surplus optional functions by detecting a mounted status change (removal or mounting) of an optional device. It should be noted that the following description will be given of different points from the second embodiment, but components and elements having the same configurations are designated by the same reference numerals and description thereof will be omitted.

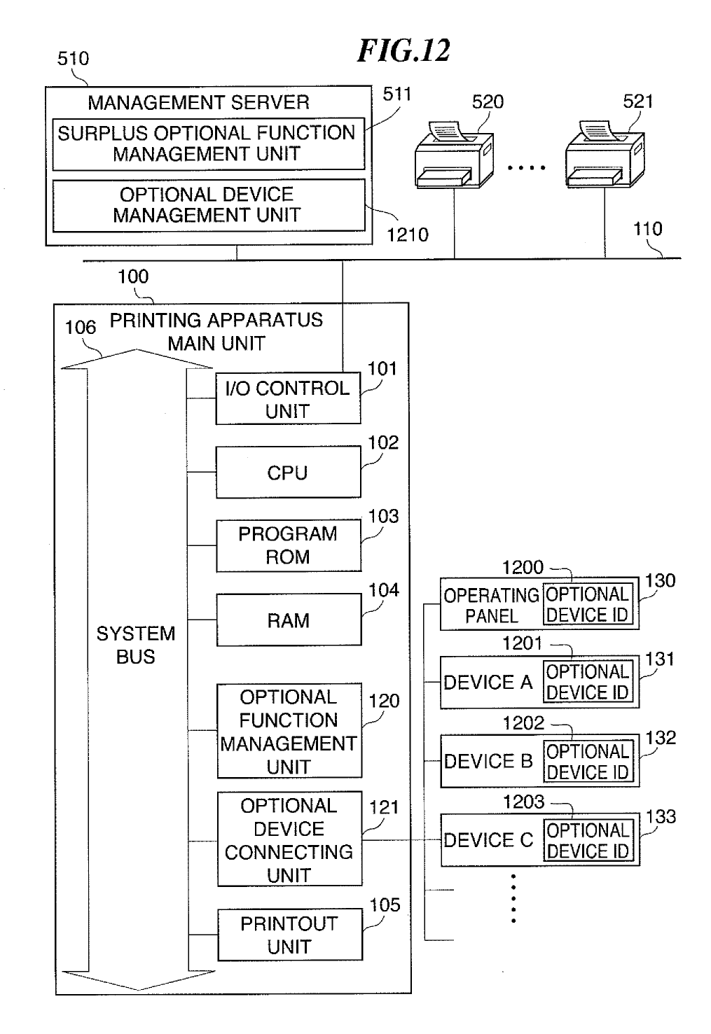

FIG. 12 is a block diagram of a printing system including a printing apparatus as an information processing apparatus according to a third embodiment of the present apparatus.

In FIG. 12, the present printing system includes the printing apparatus main unit 100, the management server 510, and the other printing apparatus 520, 521, . . . , which are connected to each other via the LAN 110.

In the present printing system, in addition to the configuration of the first embodiment, the optional devices 130 to 133 have optional device IDs 1200 to 1203. Each of the optional device IDs is an identifier which enables the associated optional device to be uniquely identified, such as the serial number of the optional device. Further, the management server 510 has an optional device management unit 1210 which manages optional devices mounted on the present printing system.

Now, a description will be given of a procedure of processing executed by the printing system configured as described above, for detecting a mounted status change of an optional device and automatically acquiring information on the surplus optional functions

Part of the procedure up to the notification executed by each printing apparatus for notifying surplus optional functions of its own to the management server 510 is the same as the surplus optional function-detecting process shown in FIG. 6, and hence description thereof is omitted.

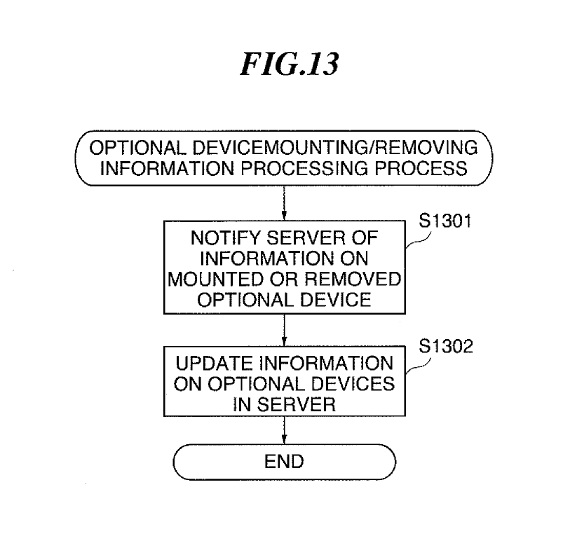

FIG. 13 is a flowchart of an optional device mounting/removing information-processing process which is executed by the printing system shown in FIG. 12. This process is executed by the CPU 102 of the printing apparatus main unit 100 and the management server 510 in FIG. 12.

Upon detection of mounting or removal of an optional device, the optional device-connecting section 121 sends information on the optional device to the management server 510 (step S1301). The management server 510 receives the notification in the step S1301, and updates the information on the optional device using the optional device management unit 1210 (step S1302), followed by terminating the present process.

Schematic diagrams illustrating information on optional functions in the present embodiment are the same as those shown in FIGS. 7A and 7B, and hence description thereof is omitted.

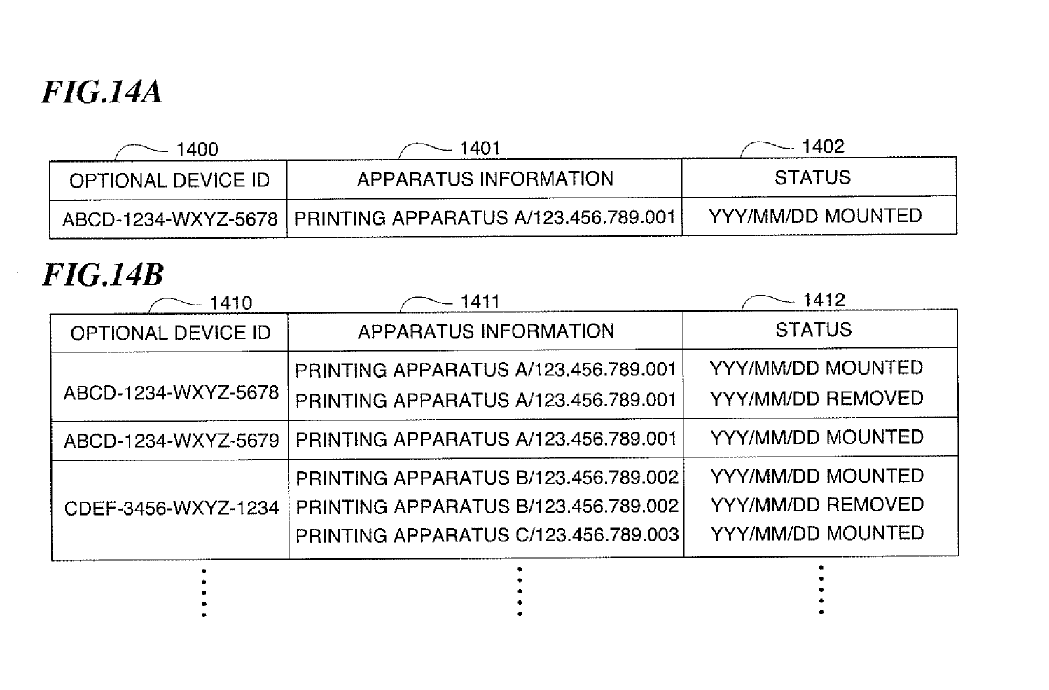

FIGS. 14A and 14B are diagrams showing tables of information on optional devices.

In FIG. 14A, there is shown information on a surplus optional function notified from the printing apparatus main unit 100 to the management server 510 in the step S1301 in FIG. 13. Each piece of optional device information includes an optional device ID 1400, apparatus information 1401 of the printing apparatus main unit 100, and a status 1402 of the optional device. The box of apparatus information 1401 stores the apparatus name (e.g. the name of a machine type) of the printing apparatus main unit 100 and an IP address thereof. The box of the status 1402 of the optional device stores information on history of mounting or removal of the optional device and date of the mounting or removal.

FIG. 14B shows an optional device management table which is stored in the optional device management unit 1210 in the step S1302 in FIG. 13, which shows states of the optional devices. When notified of information shown in FIG. 14A from each printing apparatus, the optional device management unit 1210 updates the optional device management table shown in FIG. 14B.

As shown in FIG. 14B, the information stored in the optional device management table includes the optional device ID 1410, the apparatus information 1411 on a printing apparatus on which or from which each optional device is mounted or removed, and the status 1412 of the optional device which has been mounted on or removed from the printing apparatus. Each box of the apparatus information 1411 stores the apparatus name (e.g. the name of a machine type) of each printing apparatus and an IP address, while each box of the status 1412 stores information on history of mounting or removing of the optional device and date of the mounting or removal.

When notified of new information, the new information is additionally stored in the apparatus information 1411 and the status 1412 which have been stored hitherto. This makes it possible to identify a printing apparatus on which each optional device is currently mounted or a printing apparatus on which the same was mounted in the past.

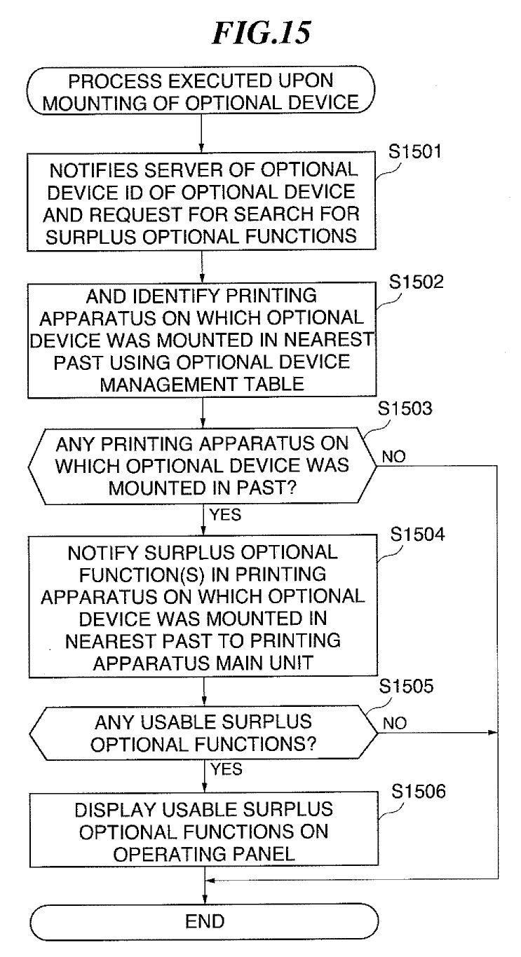

FIG. 15 is a flowchart of a process executed by the printing system shown in FIG. 12 when an optional device is mounted. This process is executed by the CPU 102 of the printing apparatus main unit 100 and the management server 510.

In FIG. 15, upon detection of mounting of a new optional device, the optional device-connecting unit 121 notifies the management server 510 of the optional device ID of the optional device and a request for search for surplus optional functions (step S1501).

The optional device management unit 1210 of the management server 510 refers to the status 1412 of the optional device of the optional device management table shown in FIG. 14B, and identifies a printing apparatus on which the optional device was mounted in the nearest past (step S1502).

Here, if there is no printing apparatus on which the optional device was mounted in the past (NO to a step S1503), the present process is immediately terminated, whereas if there is a printing apparatus on which the optional device was mounted in the past (YES to the step S1503), a surplus optional function or surplus optional functions in the printing apparatus on which the optional device was mounted in the nearest past is/are notified to the printing apparatus main unit 100 (step S1504).

Next, the surplus optional function-search unit 501 searches the surplus optional function(s) notified in the step S1504 using the table shown in FIG. 3, for one(s) which can be used by the local apparatus (step S1505).

Here, if there is/are a surplus optional function or surplus optional functions which can be used in the local apparatus (YES to the step S1505), the surplus optional function(s) which can be used in the present printing apparatus is/are displayed on the operating panel 130 (step S1506), followed by terminating the present process. On the other hand, if there are no surplus optional functions which can be used in the local apparatus (NO to the step S1505), the process is immediately terminated.

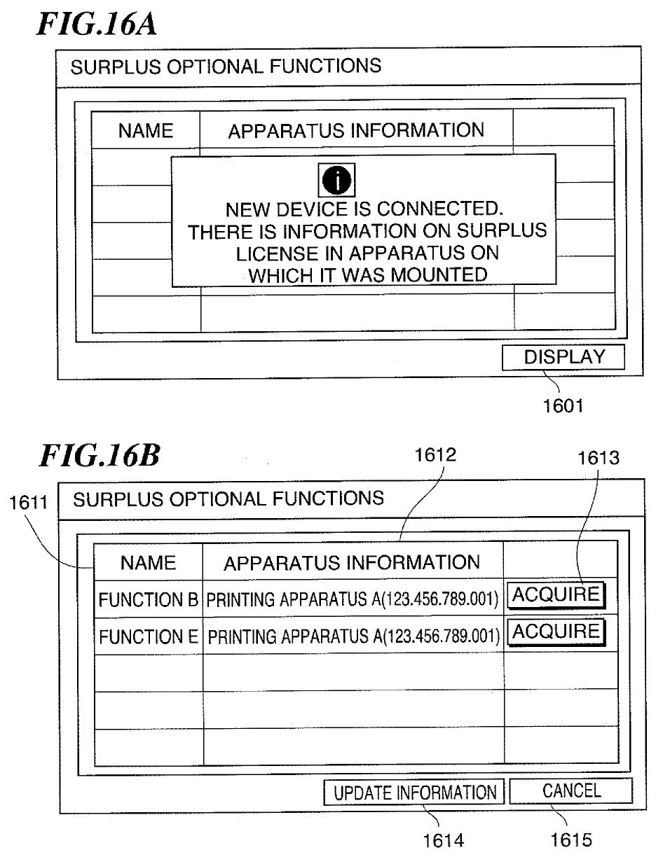

FIGS. 16A and 16B are diagrams showing respective examples of UI screens displayed in a step S1506 in FIG. 15.

FIG. 16A shows a screen for notifying the user of existence of surplus optional functions on which the newly connected optional device was mounted. When the user presses a button 1601, the screen shifts to one shown in FIG. 16B.

In the screen shown in FIG. 16B, there are displayed the name 1611 of each surplus optional function which can be used in the printing apparatus main unit 100, and the apparatus information 1612 of the printing apparatus having the surplus optional function. Each box of the apparatus information shows the apparatus name (name of a machine type) of the printing apparatus and an IP address thereof.

By pressing a button 1613 for acquiring a surplus optional function, the user can instruct acquisition of the surplus optional function. A button 1614 is for instructing the update of the information on the surplus optional functions of the printing system. A cancel button 1615 is for closing the screen without acquiring a surplus optional function.

The process for performing transfer and reception of a surplus optional function between the printing apparatuses when the user presses the button 1613 for acquiring the surplus optional function is the same as described in the second embodiment, and hence description thereof is omitted.

The processing described heretofore enables each printing apparatus to detect a mounted status change of an optional device and automatically notify the user of information on surplus optional functions.

Although in the embodiments described above, the management of surplus optional functions is carried out using the management server 510, it is possible to provide no server but send and receive information on surplus optional functions between the printing apparatuses by peer-to-peer network, whereby each printing apparatus may manage information on the surplus optional functions and information on optional devices.

It is to be understood that the present invention may also be realized by supplying a system or an apparatus with a storage medium in which a program code of software, which realizes the functions of each of the above described embodiments is stored, and causing a computer (or CPU or MPU) of the system or apparatus to read out and execute the program code stored in the storage medium.

In this case, the program code itself read from the storage medium realizes the functions of each of the above described embodiments, and therefore the program code and the storage medium in which the program code is stored constitute the present invention.

Examples of the storage medium for supplying the program code include a Floppy® disk, a hard disk, a magnetic-optical disk, optical disks, such as a CD-ROM, a CD-R, a CD-RW, a DVD-ROM, a DVD-RAM, a DVD-RW, and a DVD+RW, a magnetic tape, a nonvolatile memory card, and a ROM.

Alternatively, the program may be downloaded via a network.

Further, it is to be understood that the functions of each of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of each of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

This application claims priority from Japanese Patent Application No. 2006-318658 filed Nov. 27, 2006, which is hereby incorporated by reference herein in its entirety.

What is claimed is:

1. An information processing system including a first information processing apparatus on which an optional device for executing an optional function can be mounted, and a second information processing apparatus on which the optional device can be mounted, comprising:
a first storage unit that is provided in the first information processing apparatus and is capable of storing the optional function data for executing the optional function;
a control unit that is configured to provide control such that when the first information processing apparatus has received the optional function data from the second information processing apparatus, the optional function data is caused to be stored in said first storage unit;
a first execution unit that is configured be operable when said first storage unit has the optional function data stored therein, and the first information processing apparatus has the optional device mounted thereon, to cause the first information processing apparatus to execute the optional function using the optional device;
a second storage unit that is provided in the second information processing apparatus and is capable of storing the optional function data;
a second execution unit that is configured to be operable when said second storage unit has the optional function data stored therein, and the second information processing apparatus has the optional device mounted thereon, to cause the second information processing apparatus to execute the optional function using the optional device; and
a transfer unit that is configured to be operable when said first storage unit does not have the optional function data stored therein, and the first information processing apparatus has the optional device mounted thereon, and when said second storage unit has the optional function data stored therein, and the second information processing apparatus does not have the optional device mounted thereon, to transfer the optional function data from the second information processing apparatus to the first information processing apparatus.

2. An information processing system as claimed in claim 1, wherein said transfer unit is configured to be operable when the first information processing apparatus sends a request for transfer of the optional function data, to the second information processing apparatus, to transfer the optional function data from the second information processing apparatus to the first information processing apparatus.

3. An information processing system as claimed in claim 2, including a server apparatus that is configured to be capable of communicating with the first information processing apparatus and the second information processing apparatus,
wherein the second information processing apparatus is configured to be operable when said second storage unit has the optional function data stored therein, and the second information processing apparatus does not have the optional device mounted thereon, to send both function identifying information for identifying the optional function and apparatus identifying information for identifying the second information processing apparatus to said server apparatus, and
wherein the first information processing apparatus is configured to be operable when said first storage unit does not have the optional function data stored therein, and the first information processing apparatus has the optional device mounted thereon, to make a request for sending the apparatus identifying information associated with the function identifying information, to said server apparatus, and
wherein the first information processing apparatus is configured to be operable in response to the sending of the function identifying information to the first information processing apparatus from said server apparatus, to send the transfer request to the second information processing apparatus based on the apparatus identifying information.

4. An information processing system as claimed in claim 3, wherein the apparatus identifying information includes an IP address.

5. An information processing system as claimed in claim 1, wherein the first information processing apparatus includes a first detection unit configured to detect mounting or removal of the optional device, and
wherein the first information processing apparatus is configured to be operable when said first storage unit does not have the optional function data stored therein, to send the transfer request to the second information processing apparatus in response to detection of mounting of the optional device by said first detection unit.

6. An information processing system as claimed in claim 3, wherein the second information processing apparatus has a second detection unit configured to detect mounting or removal of the optional device, and
wherein the second information processing apparatus is operable when said second storage unit has the optional function data stored therein, to send both the function identifying information and the apparatus identifying information to said server apparatus in response to detection of removal of the optional device by said second detection unit.

7. An information processing system as claimed in claim 1, wherein the optional function data is an execution program for executing the optional function.

8. An information processing system as claimed in claim 1, wherein said first storage unit and said second storage unit stores an execution program for executing the optional function, and
wherein the optional function data is license information for permitting said first execution unit or said second execution unit to execute the optional function based on the execution program.

9. An information processing apparatus that is configured to be capable of having an optional device mounted thereon for executing an optional function, and communicating with another information processing apparatus on which the optional device can be mounted, comprising:
a first storage unit that is configured to be capable of storing the optional function data for executing the optional function;
a reception unit that is configured to be operable when said first storage unit does not have the optional function data stored therein, and the information processing apparatus has the optional device mounted thereon, and when a second storage unit provided in another information processing apparatus has the optional function data stored therein, and the other information processing apparatus does not have the optional device mounted thereon, to receive the optional function data from the other information processing apparatus;
a control unit that is configured to provide control such that when the first information processing apparatus has received the optional function data from the second information processing apparatus, the optional function data is caused to be stored in said first storage unit; and
an execution unit that is configured be operable when said first storage unit has the optional function data stored therein, and the first information processing apparatus has the optional device mounted thereon, to execute the optional function using the optional device.

10. An information processing apparatus as claimed in claim 9, including a transmission unit configured to be operable when said first storage unit does not have the optional function data stored therein, and the information processing apparatus has the optional device mounted thereon, to make a request for sending the optional function data, to the other information processing apparatus, and
wherein said control unit provides control such that when the optional function data has been received from the other information processing apparatus sent in response to sending of the transfer request, the optional function data is caused to be stored in said first storage unit.

11. An information processing apparatus as claimed in claim 10, including a first detection unit configured to detect mounting or removal of the optional device, and
wherein the said transmission unit is configured to be operable when said first storage unit does not have the optional function data stored therein, to send the transfer request to the other information processing apparatus in response to detection of mounting of the optional device by said detection unit.

12. An information processing apparatus as claimed in claim 9, wherein the optional function data is an execution program for executing the optional function.

13. An information processing apparatus as claimed in claim 9, wherein said first storage unit has an execution program stored therein for executing the optional function, and
wherein the optional function data is license information for permitting said execution unit to execute the optional function based on the execution program.

14. An information processing apparatus that is configured to be capable of having an optional device mounted thereon for executing an optional function, and communicating with another information processing apparatus on which the optional device can be mounted, comprising:
a first storage unit that is capable of storing optional function data for executing the optional function;
a transmission unit that is operable when said first storage unit has the optional function data stored therein, and the information processing apparatus does not have the optional device mounted thereon, and when a second storage unit provided in the other information processing apparatus does not have the optional function data stored therein, and the other information processing apparatus has the optional device mounted thereon, to send the optional function data to the other information processing apparatus;
an execution unit that is configured be operable when said first storage unit has the optional function data stored therein, and the information processing apparatus has the optional device mounted thereon, to execute the optional function using the optional device.

15. An information processing apparatus as claimed in claim 14, including a reception unit that is configured to receive a request for sending the optional function data, from the other information processing apparatus,
wherein said transmission unit sends the optional function data to the other information processing apparatus in response to reception of the transfer request by said reception unit.

16. An information processing apparatus as claimed in claim 14, wherein the optional function data is an execution program for executing the optional function.

17. An information processing apparatus as claimed in claim 14, wherein said first storage unit has an execution program stored therein for executing the optional function, and
wherein the optional function data is license information for permitting said execution unit to execute the optional function based on the execution program.

18. A method of processing information in an information processing system including a first information processing apparatus on which an optional device for executing an optional function can be mounted, and a second information processing apparatus on which the optional device can be mounted, comprising:
a transfer step of transferring optional function data for executing the optional function from the second information processing apparatus to the first information processing apparatus, when a first storage unit of the first information processing apparatus does not have the optional function data stored therein, and the first information processing apparatus has the optional device mounted thereon, and when a second storage unit of the second information processing apparatus has the optional function data stored therein, and the second information processing apparatus does not have the optional device mounted thereon;
a control step of providing control such that when the first information processing apparatus has received the optional function data from the second information processing apparatus, the optional function data is caused to be stored in the first storage unit;
a first execution step of causing the first information processing apparatus to execute the optional function using the optional device when the first storage unit has the optional function data stored therein, and the first information processing apparatus has the optional device mounted thereon; and
a second execution step of causing the second information processing apparatus to execute the optional function using the optional device, when the second storage unit has the optional function data stored therein, and the second information processing apparatus has the optional device mounted thereon.
